(19) United States
(12) Patent Application Publication
(10) Pub. No.: US 2011/0179358 A1
(43) Pub. Date: Jul. 21, 2011

(54) System For Managing A Plurality of Appointments, Events, and Reminders

(76) Inventor: Rajesh Gautam, Chalfont, PA (US)

(21) Appl. No.: 12/689,694

(22) Filed: Jan. 19, 2010

(51) Int. Cl. G06F 3/048; G06F 15/16

(52) U.S. Cl. 715/738

(57) ABSTRACT

A system for managing a plurality of appointments, events and reminders related to at least one user is disclosed. The system comprises at least one electronic device adapted to create the plurality of appointments, events and reminders and at least one central server adapted to store the plurality of appointments, events and reminders. The system further includes at least one electronic display device being configured to display the plurality of appointments, events and reminders by way of text, graphics and/or video and at least one electronic network operable to interconnect the at least one electronic device, the at least one central server and the at least one electronic display device. The plurality of appointments, events and reminders can be synchronized and stored locally or remotely by way of the at least one electronic device and/or central server and can be sent and/or received through the at least one electronic network.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to scheduling systems, and more particularly to a system for managing a plurality of appointments, events and reminders related to at least one user.

The implementation of scheduling systems has eased time management to keep track of appointments, events, meetings, deadlines, time sensitive paperwork, specific projects/tasks, and other activities etc. In today's busy environment, a person may require the help of a reminder system to alert a person when an important event or deadline is coming. There is a need for a user friendly scheduling system that allows a display device to show a user's appointments, events or reminders. Several types of scheduling systems have been developed in the art for personalizing appointments, events or reminders on occasioned dates.

U.S. Pat. No. 7,340,484 issued to Krishna S describes a system and method that assists in collecting, integrating, and displaying calendar data from a plurality of data source applications, including several components. In one implementation, a first client connector communicates with a first client application. A plurality of data source connectors communicates with a plurality of data source applications. Each data source connector communicates with a data source application. An integrator performs multiple functions. It receives a first calendar data request from the first client application through the first client connector. It also retrieves a plurality of calendar data items corresponding to the first calendar data request from two or more of the data source applications through the respective data source connectors. It integrates the plurality of calendar data items into a first integrated calendar data set, and it transmits the first integrated calendar data set to the first client application through the first client connector.

U.S. Pat. No. 6,961,896 issued to Rousselle describes a method and system for creating timed reminders linked to computer-readable documents. The invention permits a user to create a reminder for any date and time, and associate any data file with the reminder in such a manner that the file is automatically opened, executed, or read as applicable at the date and time specified in the reminder. A document-linked reminder may be created from any application program within an application suite through the use of a reminder creation dialog. The reminder creation dialog permits a user to specify a time and date on which the reminder will activate, along with an associated file. The reminder is then stored in a database. The reminder creation dialog may be later accessed to create additional reminders, or to edit the time, date, or associated file for existing reminders. Periodically, the document reminder system will poll the database to determine whether or not any reminders need to be activated. This polling is carried out via the application suite when active, or via a background program if the application suite is inactive. At the time and date specified, the reminder will be displayed, along with the name of the associated file and a variety of reminder options. In an exemplary embodiment, these options include the ability to reschedule, delete, or delay the reminder, as well as the ability to launch or otherwise execute the associated file.

U.S. Pat. No. 5,960,406 issued to Rasansky describes a computer system for scheduling events between end users of the system. Each end user is granted a unique password protected personal calendar. This calendar is generated from information stored in a database at a central server, and delivered to each end user as standard HTML sent through the Internet. This custom personal calendar is then viewed by the end user in a standard web browser. This obviates the need for special software programs to be purchased by end users, and also allows end users of any CPU type to read their calendars. Individuals who use the present system can post reminders to themselves, send announcements to people they know, and make appointments with people they know. When these messages are sent, the communications is nearly instantaneous because the system makes one record and allows both (or many) parties to view it.

Most of these scheduling systems for managing appointments, events and reminders described herein are complex and not user friendly. Some of these systems cannot be accessed from a remote location and are not compatible with present day electronic devices and electronic communication systems. Moreover, some of these systems are not configurable to show a user's appointments, events or reminders by way of remote or local electronic display devices.

It is therefore, an object of the present invention is to provide a simple, flexible and user friendly system for managing appointments, events and reminders related to a user. Another object of the present invention is to provide a system that can be accessed from a remote location and are compatible with the present day electronic devices and electronic communication systems. Yet another object of the present invention is to provide a system that can show a user's appointments, events or reminders by way of remote or local electronic display devices. Other objects of the present invention will become better understood with reference to the appended Summary, Description and Claims.

### SUMMARY

The present invention is a system for managing a plurality of appointments, events and reminders related to at least one user. The system comprises at least one electronic device adapted to create the plurality of appointments, events and reminders and at least one electronic display device being configured to display the plurality of appointments, events and reminders by way of text, graphics and/or video. The system further includes at least one central server adapted to store the plurality of appointments, events and reminders. In addition, the system includes at least one electronic network operable to interconnect the at least one electronic device, the at least one central server and the at least one electronic display device. The at least one electronic network may be the Internet, a wired network and a wireless network. The plurality of appointments, events and reminders can be synchronized and stored locally or remotely by way of the at least one electronic device and/or central server, and can be sent and/or received through the at least one electronic network.

The electronic device includes mobile phones, personal digital assistants (PDA), and personal computers (PC). The electronic display device is configured to communicate with the electronic device, the central server and electronic network. The electronic display device includes televisions (TV), digital frames and clocks. The electronic display device can be controlled through remote controllers, keyboards, a combination of buttons/keys, touch screens and voice commands.

The electronic display device may be designed for being snoozed and/or completely switched off. The electronic display device may be designed to display the plurality of appointments, events and reminders after a definite interval of time. The electronic display device may also be designed to display the plurality of appointments, events and reminders in parallel when the user is watching other information on the display device. The system facilitates the appointments, events, and reminders to pop up or to scroll through the display device.

The appointments, events and reminders management system includes the central server interconnected by the wireless network wherein the central server preferably includes at least one database. The electronic device, including mobile phones, personal digital assistants (PDA), and personal computers (PC), and the electronic display device, including televisions (TV), digital frames and clocks, are interconnected by the electronic network, including Internet, the wired network and the wireless network. The wired network may include plain old telephone systems (POTS) and cable television networks. The wireless network may include wireless fidelity (Wi-Fi) and Bluetooth.

### BRIEF DESCRIPTION OF THE FIGURES

FIG. 1 is a diagrammatic illustration of the present invention, illustrating a system for managing a plurality of appointments, events and reminders related to at least one user being interconnected by the Internet.

FIG. 2 is a diagrammatic illustration of the present invention, illustrating the system interconnected by a wired network.

FIG. 3 is a diagrammatic illustration of the present invention, illustrating the system interconnected by a wireless network.

FIG. 4 is a diagrammatic illustration of the present invention, illustrating the appointments, events and reminders management system including a central server interconnected by the Internet.

FIG. 5 is a diagrammatic illustration of the present invention, illustrating the system including the central server interconnected by the wired network.

FIG. 6 is a diagrammatic illustration of the present invention, illustrating the system including the central server interconnected by the wireless network.

FIG. 7 is an operational flow chart of the invention, illustrating a method for managing the plurality of appointments, events and reminders related to the at least one user.

### REFERENCE NUMERALS

10 . . . A system for managing a plurality of appointments, events and reminders related to at least one user
20 . . . At least one electronic device
22 . . . Mobile phones
24 . . . . Personal digital assistants (PDA)
26 . . . . Personal computers (PC)
30 . . . At least one electronic display device
32 . . . Televisions (TV)
34 . . . . Digital frames
36 . . . Clocks
40 . . . At least one electronic network
42 . . . Internet
44 . . . At least one wired network
46 . . . At least one wireless network
50 . . . Central server
60 . . . An operational flowchart for method of managing a plurality of appointments, events and reminders related to at least one user
62 . . . Creating a plurality of appointments, events and reminders
64 . . . Storing the plurality of appointments, events and reminders
66 . . . Interconnecting at least one electronic device and at least one electronic display device by way of Internet
68 . . . Displaying the plurality of appointments, events and reminders

### DETAILED DESCRIPTION

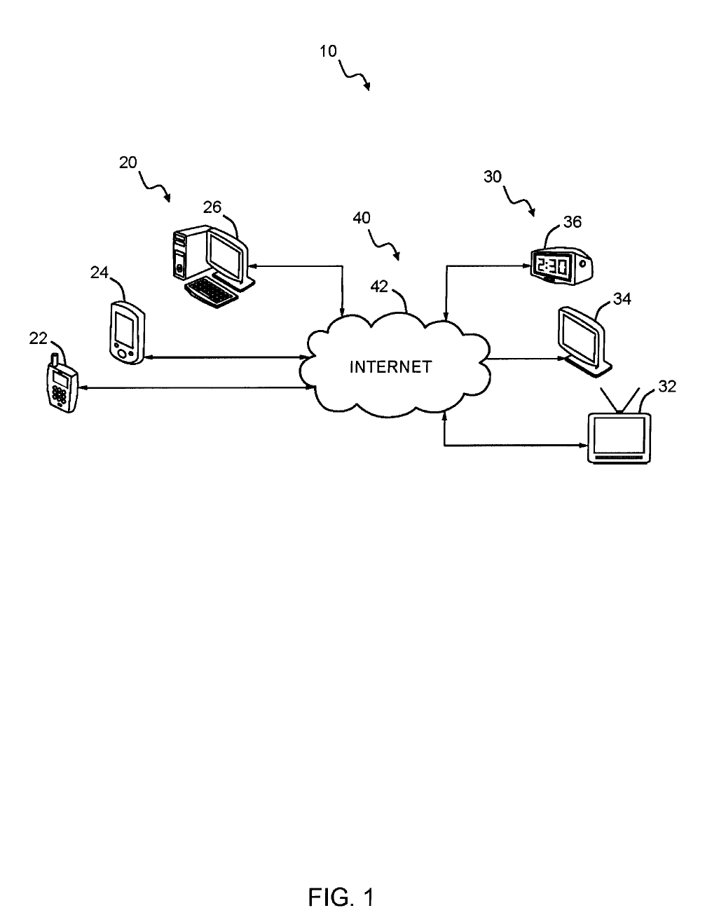

Referring to the drawings, a preferred embodiment illustrates a system 10 for managing a plurality of appointments, events and reminders related to at least one user and generally indicated in FIGS. 1 through 6. Referring to FIG. 1, the system 10 comprises at least one electronic device 20 adapted to create the plurality of appointments, events and reminders. The system may also include at least one central server (not shown) adapted to store the plurality of appointments, events and reminders. The system further includes at least one electronic display device 30 being configured to display the plurality of appointments, events and reminders by way of text, graphics and/or video. In addition, the system includes at least one electronic network 40 operable to interconnect the at least one electronic device 20, the at least one central server (not shown) and the at least one electronic display device 30.

With reference to FIG. 1, the at least one electronic device 20, the at least one central server (not shown) and the at least one electronic display device 30 is interconnected by the Internet 42. The plurality of appointments, events and reminders can be synchronized and stored locally or remotely by way of the at least one electronic device 20 and/or central server (not shown) and can be sent and/or received through the at least one electronic network 40. The at least one electronic device 20 includes mobile phones 22, personal digital assistants (PDA) 24, and personal computers (PC) 26. The plurality of appointments, events and reminders can be synchronized and stored locally by way of the at least one electronic device 20. The at least one electronic display device 30 is configured to communicate with the at least one electronic device 20, the at least one central server (not shown) and the at least one electronic network 40. The at least one electronic display device 30 includes televisions (TV) 32, digital frames 34 and clocks 36. The at least one electronic display device 30 can be controlled through remote controllers, keyboards, a combination of buttons/keys, touch screens and voice commands.

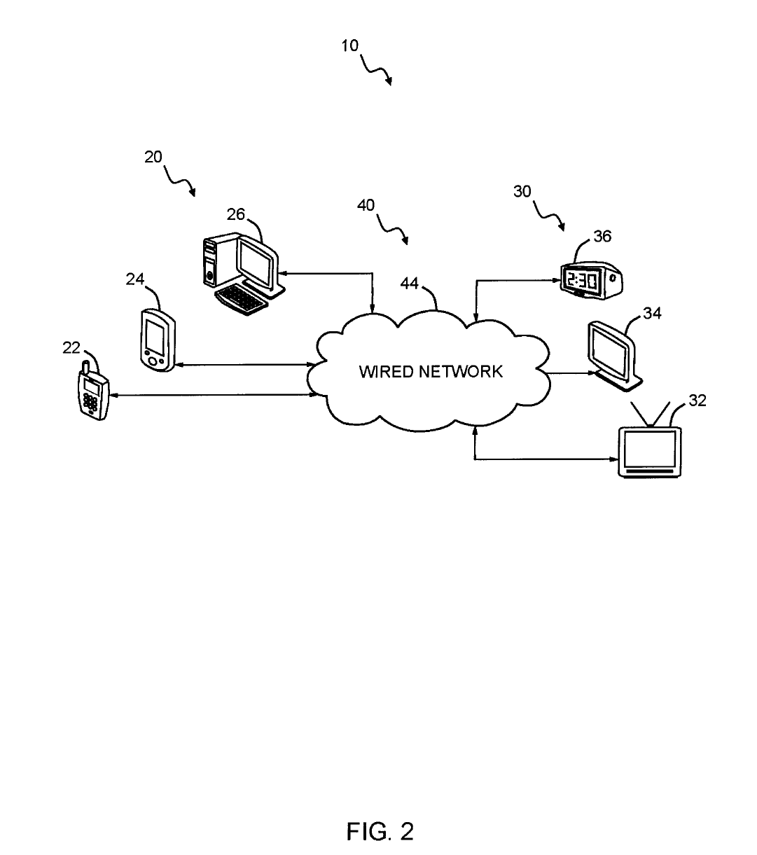

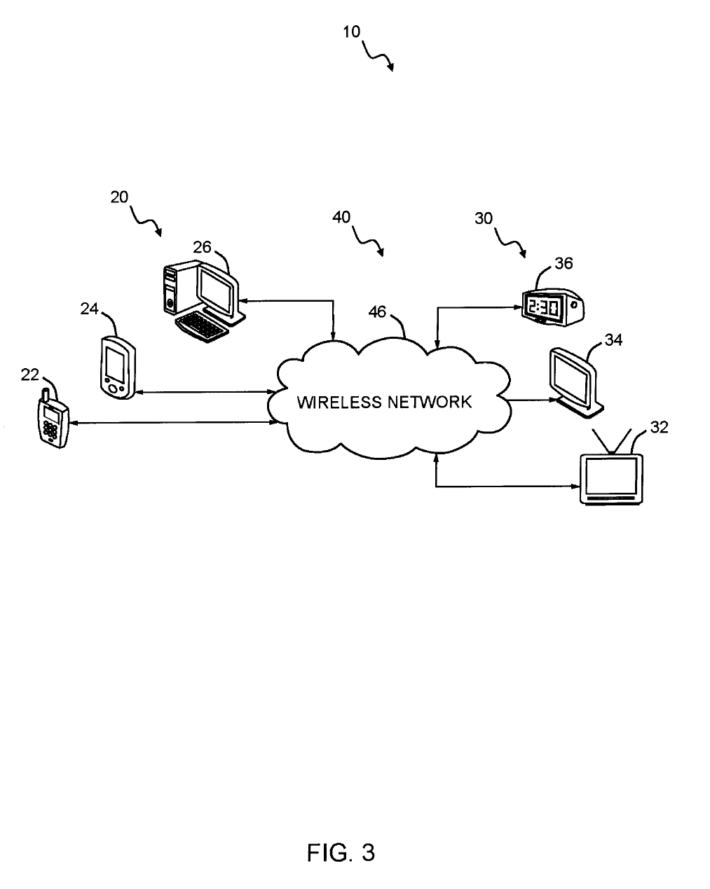

FIGS. 2 and 3 illustrate the system 10 interconnected by the at least one electronic network 40. The at least one electronic network 40 may be a wired network 44 as shown in FIG. 2 wherein the at least one electronic device 20 and the at least one electronic display device 30 are interconnected by a wired network 44. Similarly, the at least one electronic device 20 and the at least one electronic display device 30 may be interconnected by way of a wireless network 46 as shown in FIG. 3 wherein the at least one electronic device 20 includes mobile phones 22, personal digital assistants (PDA) 24, and personal computers (PC) 26. The at least one electronic display device 30 includes televisions (TV) 32, digital frames 34 and clocks 36. The at least one electronic display device 30 may be designed for being snoozed and/or completely switched off. The at least one electronic display device 30 may be designed to display the plurality of appointments, events and reminders after a definite interval of time. The at least one electronic display device 30 may also be designed to display the plurality of appointments, events and reminders in parallel when the at least one user is watching other information on the at least one display device 30. The system 10 facilitates the appointments, events, and reminders to pop up or to scroll through the at least one display device 30.

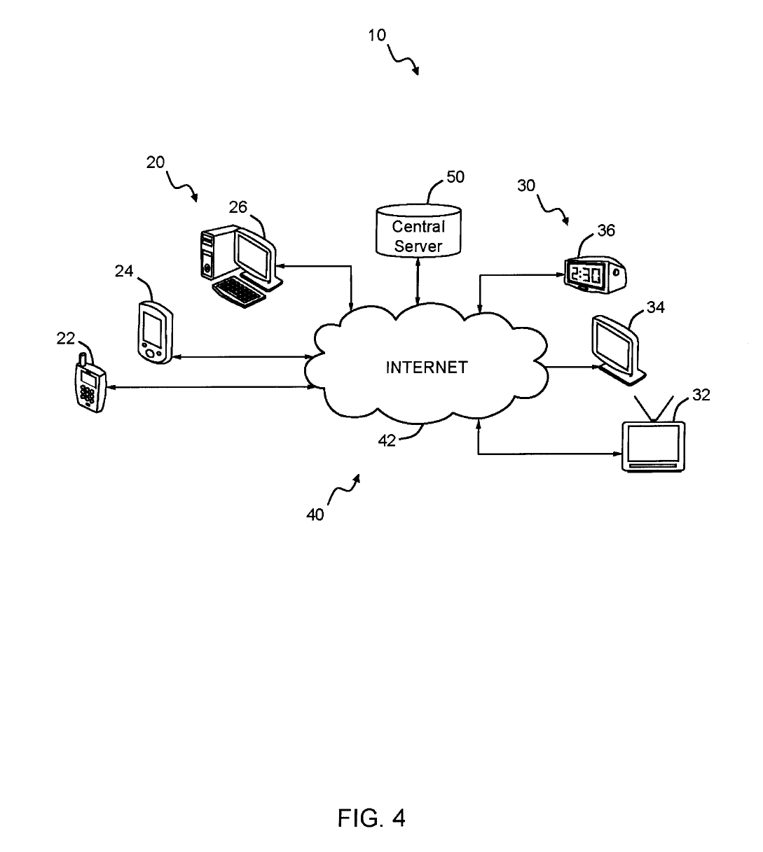

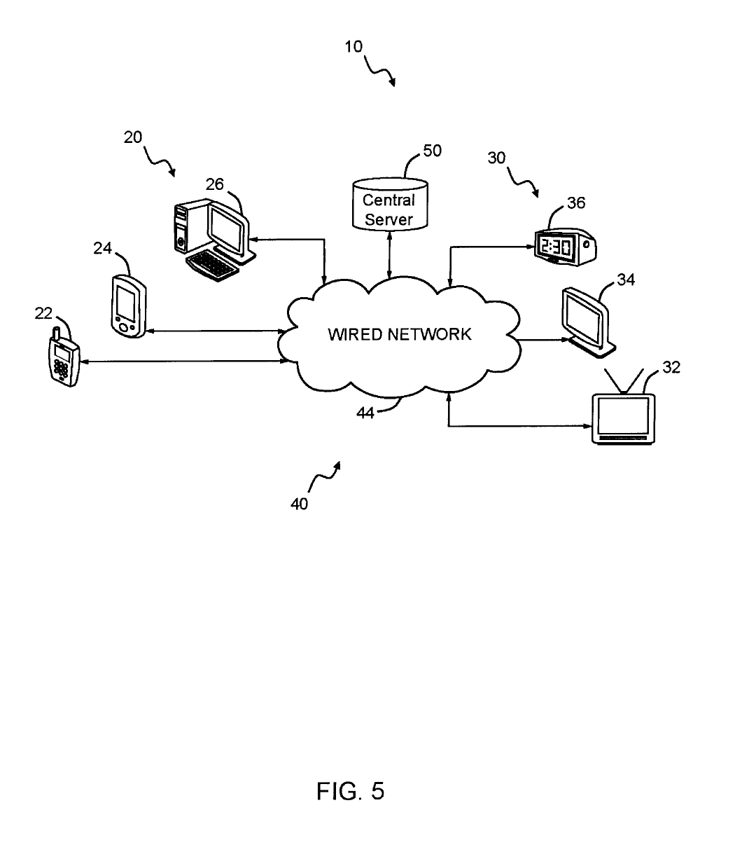

FIGS. 4, 5 and 6 illustrate the appointments, events and reminders management system 10 including a central server 50 interconnected by the at least one electronic network 40 wherein the at least one electronic network may be the Internet 42, a wired network 44, and/or wireless network 46. The at least one central server 50 preferably includes at least one database. The plurality of appointments, events and reminders may be synchronized and stored remotely by way of the at least one central server 50. The plurality of appointments, events and reminders can be sent and/or received through the at least one electronic network 40. FIG. 4 is an illustration of the appointments, events and reminders management system 10 including a central server interconnected by the Internet 42. With reference to FIG. 5, the appointments, events and reminders management system 10 that includes a central server interconnected by the wired network 44 is illustrated.

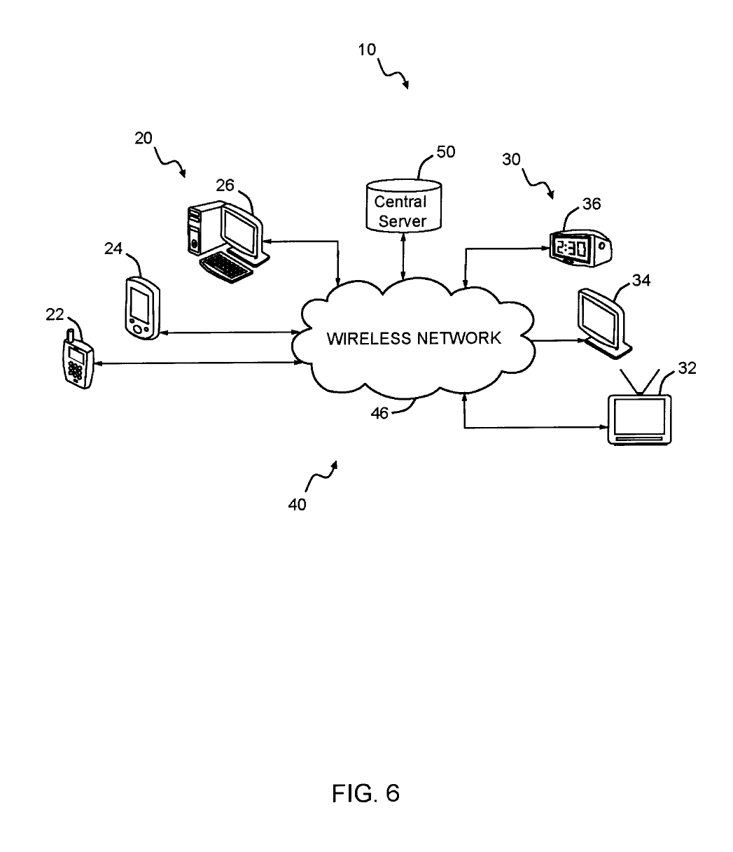

FIG. 6 is an illustration of the appointments, events and reminders management system 10 including a central server interconnected by the wireless network 46. The at least one electronic device 20 including mobile phones 22, personal digital assistants (PDA) 24, and personal computers (PC) 26; and the at least one electronic display device 30 including televisions (TV) 32, digital frames 34 and clocks 36 are interconnected by the at least one electronic network 40 including Internet 42, the wired network 44 and the wireless network 46. The wired network 44 may include plain old telephone systems (POTS) and cable television networks. The wireless network 46 may include wireless fidelity (Wi-Fi) and Bluetooth.

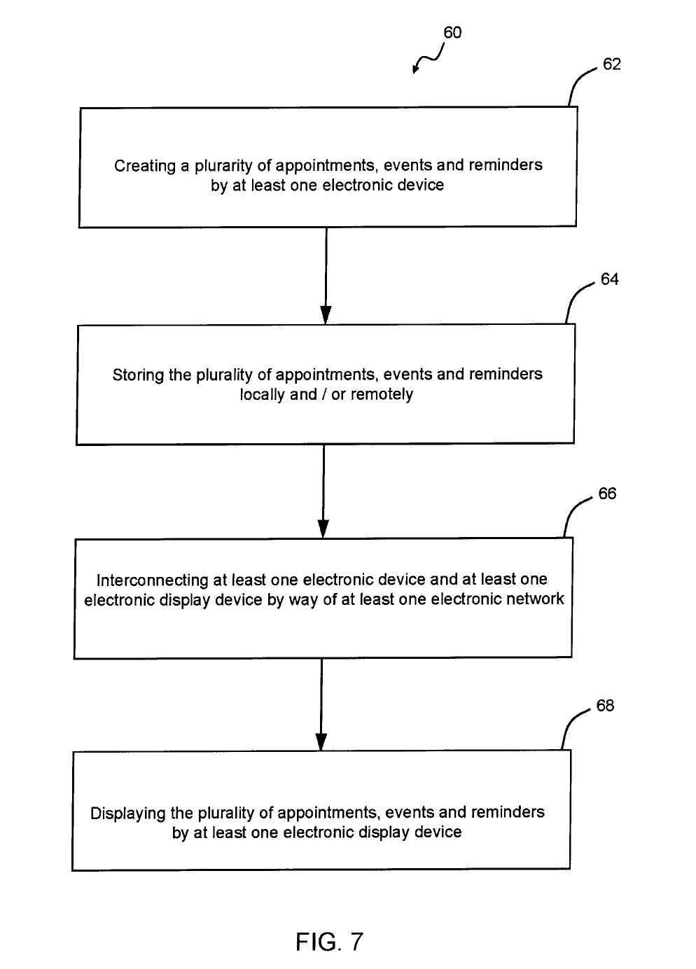

FIG. 7 shows an operational flowchart of a method for managing the plurality of appointments, events and reminders 60 related to the at least one user. The method is initiated by creating the plurality of appointments, events and reminders by the at least one electronic device as indicated at block 62. Further, the plurality of appointments, events and reminders can be stored locally and/or remotely utilizing the at least one central server and/or the at least one electronic device as indicated at block 64. As shown at block 66, the at least one electronic device and at least one electronic display device may be interconnected by way of at least one electronic network. Displaying the plurality of appointments, events and reminders by at least one electronic display device is indicated at block 68.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A system for managing a plurality of appointments, events and reminders related to at least one user, the system comprising:
at least one electronic device adapted to create the plurality of appointments, events and reminders;
at least one central server adapted to store the plurality of appointments, events and reminders;
at least one electronic network operable to interconnect the at least one electronic device, the at least one central server; and
at least one electronic display device
herein,
the at least one electronic display device is configured to display the plurality of appointments, events and reminders by way of text, graphics and/or video; and
whereby the plurality of appointments, events and reminders may be synchronized and stored locally or remotely by way of the at least one electronic device and/or central server and can be sent and/or received through the at least one electronic network.

2. The system of claim 1, wherein the at least one electronic device comprises mobile phones, personal computers (PC), and personal digital assistants (PDA).

3. The system of claim 1, wherein the at least one electronic display device comprises televisions (TV), digital frames and clocks.

4. The system of claim 1, wherein the at least one electronic display device is designed to be snoozed and/or completely switched off.

5. The system of claim 1, wherein the at least one electronic display device is designed to display the plurality of appointments, events and reminders after a definite interval of time.

6. The system of claim 1, wherein the at least one electronic display device is designed to display the plurality of appointments, events and reminders in parallel when the at least one user is watching other information on the at least one display device.

7. The system of claim 1, wherein the at least one central server comprises at least one database.

8. The system of claim 1, wherein the at least one electronic network is the Internet.

9. The system of claim 1, wherein the at least one electronic network is a wired network.

10. The system of claim 1, wherein the at least one electronic network is a wireless network.

11. The system of claim 1, wherein the at least one electronic display device is controlled through remote controllers, keyboards, a combination of buttons/keys, touch screens or voice commands.

12. A method for managing a plurality of appointments, events and reminders related to at least one user, the method comprising the steps of:
(a) creating a plurality of appointments, events and reminders with at least one electronic device;
(b) storing the plurality of appointments, events and reminders in at least one central server and/or in at least one electronic device;
(c) interconnecting the at least one electronic device and the at least one electronic display device by way of at least one electronic network; and
(d) displaying the plurality of appointments, events and reminders on at least one electronic display device.

13. The method of claim 12, wherein the at least one electronic display device is configured to communicate with the at least one electronic device, the at least one central server and the at least one electronic network.

14. The method of claim 12, wherein the plurality of appointments, events and reminders is synchronized and stored locally by way of the at least one electronic device.

15. The method of claim 12, wherein the plurality of appointments, events and reminders is synchronized and stored remotely by way of the at least one central server.
